(19) United States
(12) Patent Application Publication
(10) Pub. No.: US 2024/0400822 A1
(43) Pub. Date: Dec. 5, 2024

(54) RESIN COMPOSITION FOR MOLDING AND MOLDED ARTICLE

(71) Applicant: KANEKA CORPORATION, Osaka (JP)

(72) Inventor: Tomoaki HASHIGUCHI, Osaka (JP)

(73) Assignee: KANEKA CORPORATION, Osaka (JP)

(21) Appl. No.: 18/806,471

(22) Filed: Aug. 15, 2024

Related U.S. Application Data
(63) Continuation-in-part of application No. PCT/JP2023/003113, filed on Jan. 31, 2023.

(30) Foreign Application Priority Data
Feb. 15, 2022 (JP) 2022-021208

(51) Int. Cl. C08L 67/04; B29C 48/32; B29L 23/00; C08K 5/14

(52) U.S. Cl. CPC C08L 67/04; B29C 48/32; C08K 5/14; B29K 2867/04; B29L 2023/008; C08L 2201/06; C08L 2203/16; C08L 2203/18; C08L 2205/025; C08L 2205/24

(57) ABSTRACT

A resin tube contains: a poly(3-hydroxyalkanoate) resin (A) including at least one copolymer of 3-hydroxybutyrate units and other hydroxyalkanoate units; and a reaction product (B) of a poly(3-hydroxyalkanoate) resin (b1) and an organic peroxide (b2), the poly(3-hydroxyalkanoate) resin (b1) including at least one copolymer of 3-hydroxybutyrate units and other hydroxyalkanoate units. The poly(3-hydroxyalkanoate) resin (b1) includes a copolymer (b1-1) in which a content of the other hydroxyalkanoate units is from 1 to 6 mol % and/or a copolymer (b1-2) in which a content of the other hydroxyalkanoate units is from 24 to 99 mol %. The proportion of the poly(3-hydroxyalkanoate) resin (A) is from 20 to 99 wt % and the proportion of the reaction product (B) is from 1 to 80 wt % in the total amount of the poly(3-hydroxyalkanoate) resin (A) and the reaction product (B).

### CROSS-REFERENCE TO RELATED APPLICATIONS

The present application is a bypass continuation-in-part of PCT Filing PCT/JP 2023-003113, filed Jan. 31, 2023, which claims priority to JP 2022-021208, filed Feb. 15, 2022, both of which are incorporated by reference in their entirety.

### BACKGROUND OF THE INVENTION

### Field of the Invention

The present invention relates to a resin composition for molding that contains a poly(3-hydroxyalkanoate) resin and to a molded article.

### Description of the Related Art

In recent years, separate collection and composting of raw garbage have been promoted especially in Europe, and plastic products that can be composted together with raw garbage have been desired. Additionally, marine pollution caused by microplastics has become an issue of great concern, and there is a demand for development of plastics degradable in seawater.

Poly(3-hydroxyalkanoate) resins are thermoplastic polyesters produced and accumulated as energy storage substances in the cells of many kinds of microorganisms. These resins are biodegradable in seawater as well as in soil and thus are attracting attention as materials that can be a solution to the above-mentioned problems.

WO 2020/040093 discloses a resin tube pliable and suitable for use as a straw. This resin tube is formed from a poly(3-hydroxybutyrate) resin and has a wall thickness of 0.1 to 0.6 mm.

### SUMMARY OF THE INVENTION

A molded article such as a resin tube is required to have a small wall thickness in terms of, for example, enhancing the biodegradability of the molded article or reducing the production cost of the molded article.

With the technique disclosed in WO 2020/040093, a poly(3-hydroxybutyrate) resin can be molded into a resin tube; however, tubes disclosed in Examples of WO 2020/040093 have a wall thickness of at least 0.2 mm, and a resin tube with a sufficiently small wall thickness is difficult to produce by molding using the technique of WO 2020/040093.

In view of the above circumstances, the present invention aims to provide a resin composition for molding that contains a poly(3-hydroxyalkanoate) resin component and the use of which allows the resulting molded article to have a small wall thickness.

As a result of intensive studies with the goal of solving the above problem, the present inventors have found that when a resin composition for molding contains a poly(3-hydroxyalkanoate) resin component composed of a poly(3-hydroxyalkanoate) resin (A) and a reaction product (B) of a poly(3-hydroxyalkanoate) resin (b1) and an organic peroxide (b2), the use of the resin composition for molding allows the resulting molded article to have a small wall thickness. Based on this finding, the inventors have completed the present invention.

Specifically, the present invention relates to a resin composition for molding, containing:
a poly(3-hydroxyalkanoate) resin (A) including at least one copolymer of 3-hydroxybutyrate units and other hydroxyalkanoate units; and
a reaction product (B) of a poly(3-hydroxyalkanoate) resin (b1) and an organic peroxide (b2), the poly(3-hydroxyalkanoate) resin (b1) including at least one copolymer of 3-hydroxybutyrate units and other hydroxyalkanoate units, wherein
the poly(3-hydroxyalkanoate) resin (b1) includes a copolymer (b1-1) in which a content of the other hydroxyalkanoate units is from 1 to 6 mol % and/or a copolymer (b1-2) in which a content of the other hydroxyalkanoate units is from 24 to 99 mol %, and
a proportion of the poly(3-hydroxyalkanoate) resin (A) is from 20 to 99 wt % and a proportion of the reaction product (B) is from 1 to 80 wt % in a total amount of the poly(3-hydroxyalkanoate) resin (A) and the reaction product (B).

The present invention also relates to a molded article containing the resin composition for molding.

The present invention further relates to a method for producing the molded article, the method including the steps of:
reacting the poly(3-hydroxyalkanoate) resin (b1) and the organic peroxide (b2) to obtain the reaction product (B);
mixing the reaction product (B) and the poly(3-hydroxyalkanoate) resin (A) to obtain a mixture; and
molding the mixture into a molded article.

The present invention can provide a resin composition for molding that contains a poly(3-hydroxyalkanoate) resin component and the use of which allows the resulting molded article to have a small wall thickness.

### BRIEF DESCRIPTION OF THE DRAWINGS

FIG. 1 shows an example of a GPC chart related to a molded article according to a preferred aspect of the present invention.

FIG. 2 shows a GPC chart measured for a molded article produced in Example 1.

### DETAILED DESCRIPTION

Hereinafter, embodiments of the present invention will be described. The present invention is not limited to the embodiments described below.

One embodiment of the present invention relates to a resin composition for molding that contains a poly(3-hydroxyalkanoate) resin (A) and a reaction product (B) of a poly(3-hydroxyalkanoate) resin (b1) and an organic peroxide (b2).

### [Poly(3-Hydroxyalkanoate) Resin (A)]

The poly(3-hydroxyalkanoate) resin (A) (hereinafter also referred to as “P3HA (A)”) contained in the resin composition for molding is a polymer containing 3-hydroxyalkanoate structural units (monomer units). The P3HA (A) is substantially a resin that has not reacted with any organic peroxide and contains no crosslinked structure formed by a reaction with an organic peroxide. The inclusion of the P3HA (A) increases the overall crystallinity of the poly(3-hydroxyalkanoate) resin component contained in the resin composition for molding and improves the moldability of the resin composition, allowing for continuous molding of the resin composition by melt extrusion. The P3HA (A) used may be one poly(3-hydroxyalkanoate) resin or a combination of two or more poly(3-hydroxyalkanoate) resins.

Specifically, the 3-hydroxyalkanoate structural units are preferably structural units represented by the following formula (1).

[—OCHR—CH₂—C(O)—] (1)

In the formula (1), R is an alkyl group represented by CₚH₂ₚ₊₁, and p is an integer from 1 to 15. Examples of R include linear or branched alkyl groups such as methyl, ethyl, propyl, methylpropyl, butyl, isobutyl, t-butyl, pentyl, and hexyl groups. The integer p is preferably from 1 to 10 and more preferably from 1 to 8.

The P3HA (A) is particularly preferably a microbially produced poly(3-hydroxyalkanoate) resin. In the microbially produced poly(3-hydroxyalkanoate) resin, all of the 3-hydroxyalkanoate structural units are contained as (R)-3-hydroxyalkanoate structural units.

The P3HA (A) preferably contains 50 mol % or more 3-hydroxyalkanoate structural units (in particular, the structural units represented by the formula (1)) in total structural units, and the content of the 3-hydroxyalkanoate structural units is more preferably 60 mol % or more and even more preferably 70 mol % or more. The P3HA (A) may contain only one type or two or more types of 3-hydroxyalkanoate structural units as repeating units constituting the polymer or may contain other structural units (such as 4-hydroxyalkanoate structural units) in addition to the one type or two or more types of 3-hydroxyalkanoate structural units.

Specific examples of the P3HA (A) include poly(3-hydroxybutyrate), poly(3-hydroxybutyrate-co-3-hydroxypropionate), poly(3-hydroxybutyrate-co-3-hydroxyvalerate) abbreviated as “P3HB3HV”, poly(3-hydroxybutyrate-co-3-hydroxyvalerate-3-hydroxyhexanoate), poly(3-hydroxybutyrate-co-3-hydroxyhexanoate) abbreviated as “P3HB3HH”, poly(3-hydroxybutyrate-co-3-hydroxyheptanoate), poly(3-hydroxybutyrate-co-3-hydroxyoctanoate), poly(3-hydroxybutyrate-co-3-hydroxynonanoate), poly(3-hydroxybutyrate-co-3-hydroxydecanoate), poly(3-hydroxybutyrate-co-3-hydroxyundecanoate), and poly(3-hydroxybutyrate-co-4-hydroxybutyrate) abbreviated as “P3HB4HB”.

In the present embodiment, the P3HA (A) includes at least one copolymer of 3-hydroxybutyrate units (hereinafter also referred to as “3HB”) and other hydroxyalkanoate units. The P3HA (A) may include only one such copolymer or two or more such copolymers. The P3HA (A) may consist only of the at least one copolymer or may include poly(3-hydroxybutyrate), i.e., a homopolymer of 3-hydroxybutyrate, in addition to the at least one copolymer.

In terms of factors such as the reduction in wall thickness, the productivity in production, and the strength, of the molded article, the copolymer of 3-hydroxybutyrate units and other hydroxyalkanoate units, which is included in the P3HA (A), is preferably at least one selected from the group consisting of poly(3-hydroxybutyrate-co-3-hydroxyvalerate), poly(3-hydroxybutyrate-co-3-hydroxyvalerate-co-3-hydroxyhexanoate), poly(3-hydroxybutyrate-co-3-hydroxyhexanoate), and poly(3-hydroxybutyrate-co-4-hydroxybutyrate), more preferably poly(3-hydroxybutyrate-co-3-hydroxyhexanoate) and/or poly(3-hydroxybutyrate-co-4-hydroxybutyrate), and even more preferably poly(3-hydroxybutyrate-co-3-hydroxyhexanoate).

In terms of factors such as the reduction in wall thickness, the productivity in production, and the strength, of the molded article, the average content ratio between 3-hydroxybutyrate units and other hydroxyalkanoate units (3-hydroxybutyrate units/other hydroxyalkanoate units) in the P3HA (A) is preferably from 99/1 to 94/6 (mol %/mol %) and more preferably from 98/2 to 94/6 (mol %/mol %).

The average content of certain monomer units in the P3HA (A) can be determined by a method known to those skilled in the art, such as a method described in paragraph [0047] of WO 2013/147139. The “average content” refers to the proportion of the monomer units in total monomer units contained in the total P3HA (A). When the P3HA (A) is a mixture of two or more poly(3-hydroxyalkanoate) resins, the average content of certain monomer units refers to the proportion of the monomer units contained in the total mixture.

The weight-average molecular weight of the P3HA (A) is not limited to a particular range. In terms of factors such as the reduction in wall thickness, the productivity in production, and the strength, of the molded article, the weight-average molecular weight of the P3HA (A) is preferably from 20×10⁴ to 200×10⁴, more preferably from 25×10⁴ to 150×10⁴, and even more preferably from 30×10⁴ to 100×10⁴.

The method for producing the P3HA (A) is not limited to using a particular technique and may be a production method using chemical synthesis or a microbial production method. A microbial production method is preferred. The microbial production method used can be any known method. Known examples of bacteria that produce copolymers of 3-hydroxybutyrate with other hydroxyalkanoates include Aeromonas caviae which is a P3HB3HV- and P3HB3HH-producing bacterium and Alcaligenes eutrophus which is a P3HB4HB-producing bacterium. In particular, in order to increase the P3HB3HH productivity, Alcaligenes eutrophus AC32 (FERM BP-6038; see T. Fukui, Y Doi, J Bacteriol., 179, pp. 4821-4830 (1997)) having a P3HA synthase gene introduced is more preferred. Such a microorganism is cultured under suitable conditions to allow the microorganism to accumulate P3HB3HH in its cells, and the microbial cells accumulating P3HB3HH are used. Instead of the above microorganism, a genetically modified microorganism having any suitable poly(3-hydroxyalkanoate) resin synthesis-related gene introduced may be used depending on the poly(3-hydroxyalkanoate) resin to be produced. The culture conditions including the type of the substrate may be optimized depending on the poly(3-hydroxyalkanoate) resin to be produced. Through these procedures, the content of 3-hydroxybutyrate units in the poly(3-hydroxyalkanoate) resin can be adjusted.

### [Reaction Product (B)]

The reaction product (B) contained in the resin composition for molding is a reaction product of a poly(3-hydroxyalkanoate) resin (b1) and an organic peroxide (b2). The reaction product has a crosslinked structure of the poly(3-hydroxyalkanoate) resin that arises from the reaction with the organic peroxide. The introduction of the crosslinked structure into the poly(3-hydroxyalkanoate) resin (b1) increases the melt tension of the resin and enhances the resistance against gas pressure applied to the resin during molding. This allows for molding of the resin composition into a molded article with a small wall thickness.

As a result of the reaction with the organic peroxide (b2), the resin composition for molding according to the present embodiment could contain an organic peroxide-derived component (such as a decomposition product of the organic peroxide or a compound derived from the decomposition product).

The amounts of the P3HA (A) and the reaction product (B) are chosen, in view of the effects achieved by these components, such that the proportion of the P3HA (A) is from 20 to 99 wt % and the proportion of the reaction product (B) is from 1 to 80 wt % in the total amount of the P3HA (A) and the reaction product (B). In terms of the productivity in production and the reduction in wall thickness of the molded article, it is preferable that the proportion of the P3HA (A) be from 20 to 90 wt % and the proportion of the reaction product (B) be from 10 to 80 wt %, and it is more preferable that the proportion of the P3HA (A) be from 20 to 80 wt % and the proportion of the reaction product (B) be from 20 to 80 wt %.

[Poly(3-Hydroxyalkanoate) Resin (b1)]

The poly(3-hydroxyalkanoate) resin (b1) (hereinafter also referred to as “P3HA (b1)”) for forming the reaction product (B) is a polymer containing 3-hydroxyalkanoate structural units (monomer units). The details of the P3HA (b1) are the same as those of the P3HA (A), except for the features described below.

The P3HA (b1) includes at least one copolymer of 3-hydroxybutyrate units and other hydroxyalkanoate units. In terms of factors such as the reduction in wall thickness, the productivity in production, and the strength, of the molded article, the copolymer preferably includes at least one selected from the group consisting of poly(3-hydroxybutyrate-co-3-hydroxyvalerate), poly(3-hydroxybutyrate-co-3-hydroxyvalerate-co-3-hydroxyhexanoate), poly(3-hydroxybutyrate-co-3-hydroxyhexanoate), and poly(3-hydroxybutyrate-co-4-hydroxybutyrate), more preferably includes poly(3-hydroxybutyrate-co-3-hydroxyhexanoate) and/or poly(3-hydroxybutyrate-co-4-hydroxybutyrate), and even more preferably includes poly(3-hydroxybutyrate-co-3-hydroxyhexanoate).

In terms of factors such as the reduction in wall thickness, the productivity in production, and the strength, of the molded article, the average content ratio between 3-hydroxybutyrate units and other hydroxyalkanoate units (3-hydroxybutyrate units/other hydroxyalkanoate units) in the P3HA (b1) is preferably from 94/6 to 50/50 (mol %/mol %), more preferably from 92/8 to 60/40 (mol %/mol %), even more preferably from 90/10 to 70/30 (mol %/mol %), and particularly preferably from 88/12 to 80/20 (mol %/mol %).

The average content of certain monomer units in the P3HA (b1) can be determined as described above for the P3HA (A). The “average content” refers to the proportion of the monomer units in total monomer units contained in the total P3HA (b1). When the P3HA (b1) is a mixture of two or more poly(3-hydroxyalkanoate) resins, the average content of certain monomer units refers to the proportion of the monomer units contained in the total mixture.

In one aspect of the present disclosure, the P3HA (b1) preferably includes two or more copolymers each of which is a copolymer of 3-hydroxybutyrate units and other hydroxyalkanoate units and which differ in the content of the other hydroxyalkanoate units from each other. The other hydroxyalkanoate units contained in the two or more copolymers may be the same or different between the two or more copolymers.

An example of the combination of two copolymers is a combination of a high-crystallinity copolymer (b1-1) in which the content of the other hydroxyalkanoate units is relatively low and a low-crystallinity copolymer (b1-2) in which the content of the other hydroxyalkanoate units is relatively high. According to this aspect, the molded article produced can have high strength.

In the high-crystallinity copolymer (b1-1), the content of the other hydroxyalkanoate units is preferably from 1 to 6 mol % and more preferably from 2 to 6 mol %.

The high-crystallinity copolymer (b1-1) is preferably poly(3-hydroxybutyrate-co-3-hydroxyhexanoate) or poly(3-hydroxybutyrate-co-4-hydroxybutyrate) and more preferably poly(3-hydroxybutyrate-co-3-hydroxyhexanoate).

In the low-crystallinity copolymer (b1-2), the content of the other hydroxyalkanoate units is preferably from 24 to 99 mol %, more preferably from 24 to 50 mol %, even more preferably from 24 to 35 mol %, and particularly preferably from 24 to 30 mol %.

The low-crystallinity copolymer (b1-2) is preferably poly(3-hydroxybutyrate-co-3-hydroxyhexanoate) or poly(3-hydroxybutyrate-co-4-hydroxybutyrate) and more preferably poly(3-hydroxybutyrate-co-3-hydroxyhexanoate).

When the high-crystallinity copolymer (b1-1) and the low-crystallinity copolymer (b1-2) are used in combination, the proportion of each resin to the total amount of the two copolymers is not limited to a particular range. Preferably, the proportion of the copolymer (b1-1) is from 10 to 90 wt % and the proportion of the copolymer (b1-2) is from 10 to 90 wt %. More preferably, the proportion of the copolymer (b1-1) is from 20 to 80 wt % and the proportion of the copolymer (b1-2) is from 20 to 80 wt %. Even more preferably, the proportion of the copolymer (b1-1) is from 30 to 70 wt % and the proportion of the copolymer (b1-2) is from 30 to 70 wt %.

In another aspect of the present disclosure, the P3HA (b1) may consist only of the copolymer (b1-1) which is a copolymer of 3-hydroxybutyrate units and other hydroxyalkanoate units. In this case, in terms of the productivity in production of the molded article, the content of the other hydroxyalkanoate units in the copolymer (b1-1) is preferably from 1 to less than 6 mol % and more preferably from 2 to 4 mol %.

In another aspect of the present disclosure, the P3HA (b1) may consist only of the copolymer (b1-2) which is a copolymer of 3-hydroxybutyrate units and other hydroxyalkanoate units. In this case, the content of the other hydroxyalkanoate units in the copolymer (b1-2) is preferably from 24 to 99 mol %, more preferably from 24 to 50 mol %, even more preferably from 24 to 35 mol %, and particularly preferably from 24 to 30 mol %.

The weight-average molecular weight of the P3HA (b1) is not limited to a particular range. In terms of factors such as the reduction in wall thickness, the productivity in production, and the strength, of the molded article, the weight-average molecular weight of the P3HA (b1) is preferably from 20×10⁴ to 200×10⁴, more preferably from 25×10⁴ to 150×10⁴, and even more preferably from 30×10⁴ to 100×10⁴. The P3HA (b1) can be produced in the same manner as the P3HA (A).

The reaction product (B) may contain only the P3HA (b1) as a resin component or may further contain a resin (in particular, a biodegradable resin) other than the P3HA (b1). Such a resin may be an additional resin as described later. The amount of the resin other than the P3HA (b1) in the reaction product (B) is not limited to a particular range and may be from 0 to less than 5 parts by weight, from 0 to 3 parts by weight, or from 0 to 1 parts by weight per 100 parts by weight of the resin composition for molding.

(Organic Peroxide (b2))

Examples of the organic peroxide (b2) to be reacted with the P3HA (b1) include, but are not limited to, diisobutyl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, bis(4-t-butylcyclohexyl) peroxydicarbonate, bis(2-ethylhexyl) peroxydicarbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl) peroxide, dilauroyl peroxide, 1,1,3,3-tetramethylbutyl peroxy-2-ethylhexanoate, disuccinic acid peroxide, 2,5-dimethyl-2,5-bis(2-ethylhexanoylperoxy)hexane, t-hexyl peroxy-2-ethylhexanoate, di(4-methylbenzoyl) peroxide, dibenzoyl peroxide, t-butylperoxy-2-ethylhexyl carbonate, t-butylperoxyisopropyl carbonate, 1,6-bis(t-butylperoxycarbonyloxy)hexane, t-butyl peroxy-3,5,5-trimethylhexanoate, t-butyl peroxyacetate, t-butyl peroxybenzoate, t-amyl peroxy-3,5,5-trimethylhexanoate, 2,2-bis(4,4-di-t-butylperoxycyclohexyl)propane, and 2,2-di-t-butylperoxy butane. Among these, dibenzoyl peroxide, t-butylperoxy-2-ethylhexyl carbonate, and t-butylperoxyisopropyl carbonate are preferred. One organic peroxide may be used alone, or two or more organic peroxides may be used in combination.

The organic peroxide (b2) may be used in any form such as a solid or a liquid. The organic peroxide (b2) may be a liquid diluted with a diluent or the like. An organic peroxide miscible with the poly(3-hydroxyalkanoate) resin (in particular, an organic peroxide that is liquid at room temperature (25° C.)) is preferred because such an organic peroxide can be uniformly dispersed in the poly(3-hydroxyalkanoate) resin to prevent a local modification reaction.

In terms of factors such as the reduction in wall thickness, the productivity in production, and the strength, of the molded article, the amount of the organic peroxide (b2) used is preferably from 0.01 to 0.5 parts by weight, more preferably from 0.05 to 0.4 parts by weight, and even more preferably from 0.1 to 0.3 parts by weight per 100 parts by weight of the P3HA (b1).

The reaction product (B) is preferably obtained by placing the P3HA (b1) and the organic peroxide (b2) into an extruder and melting and kneading them together in the extruder. In this case, the P3HA (b1) can be uniformly crosslinked. In the melting and kneading, other components described later such as a nucleating agent, a lubricant, and an organic or inorganic filler may be placed into the extruder in addition to the P3HA (b1) and the organic peroxide (b2).

In the melting and kneading, each of the P3HA (b1) and the organic peroxide (b2) may be individually placed into the extruder. Alternatively, these components may be mixed beforehand, and then the mixture may be placed into the extruder.

The melting and kneading can be carried out according to a known or conventional method. For example, the melting and kneading can be carried out using a device such as an extruder (single-screw or twin-screw extruder) or a kneader. The conditions of the melting and kneading are not limited to particular details and can be set as appropriate. The resin temperature and the residence time are preferably set such that the reaction with the organic peroxide (b2) can be completed during the melting and kneading. Specifically, in the melting and kneading, the resin temperature as measured by a thermometer on the die is preferably from 155 to 175° C. In the melting and kneading, the residence time in the extruder is preferably from 60 to 300 seconds.

The reaction product (B) can be produced also by reacting the P3HA (b1) and the organic peroxide (b2) in an aqueous dispersion. In this case, an aqueous P3HA (b1) dispersion containing the organic peroxide (b2) may be heated to a temperature suitable for modification to allow the reaction to proceed efficiently.

### [Additional Resin]

The resin component contained in the resin composition for molding may consist only of the P3HA (A) and the reaction product (B) or may contain an additional resin that is not classified as a poly(3-hydroxyalkanoate) resin in addition to the P3HA (A) and the reaction product (B). Examples of the additional resin include: aliphatic polyester resins such as polylactic acid, polybutylene succinate adipate, polybutylene succinate, and polycaprolactone; and aliphatic-aromatic polyester resins such as polybutylene adipate terephthalate, polybutylene sebacate terephthalate, and polybutylene azelate terephthalate. The resin component may contain only one additional resin or two or more additional resins.

The amount of the additional resin is not limited to a particular range, but is preferably small in terms of the degradability of the molded article in seawater. Specifically, the amount of the additional resin is preferably 35 parts by weight or less, more preferably 30 parts by weight or less, even more preferably 20 parts by weight or less, and still even more preferably 10 parts by weight or less per 100 parts by weight of the total amount of the P3HA (A) and the reaction product (B). The lower limit of the amount of the additional resin is not limited to a particular value and may be 0 part by weight.

### [Inorganic Filler]

The resin composition for molding need not contain any inorganic filler, but preferably contains an inorganic filler in terms of enhancing the strength of the molded article.

The inorganic filler is not limited to a particular type and may be any inorganic filler that can be used in molded articles. Examples of the inorganic filler include: silica-based inorganic fillers such as quartz, fumed silica, silicic anhydride, molten silica, crystalline silica, amorphous silica, a filler obtained by condensation of alkoxysilane, and ultrafine amorphous silica; and other inorganic fillers such as alumina, zircon, iron oxide, zinc oxide, titanium oxide, silicon nitride, boron nitride, aluminum nitride, silicon carbide, glass, silicone rubber, silicone resin, titanium oxide, carbon fiber, mica, black lead, carbon black, ferrite, graphite, diatomite, white clay, clay, talc, calcium carbonate, manganese carbonate, magnesium carbonate, barium sulfate, and silver powder. One of these fillers may be used alone, or two or more thereof may be used in combination.

The inorganic filler may be surface-treated in order to increase its dispersibility in the resin composition for molding. Examples of the treatment agent used for the surface treatment include higher fatty acids, silane coupling agents, titanate coupling agents, sol-gel coating agents, and resin coating agents.

The water content of the inorganic filler is preferably from 0.01 to 10%, more preferably from 0.01 to 5%, and even more preferably from 0.01 to 1% in order to reliably inhibit hydrolysis of the poly(3-hydroxyalkanoate) resins. The water content can be determined according to JIS K 5101.

The average particle size of the inorganic filler is preferably from 0.1 to 100 μm, more preferably from 0.1 to 50 μm, even more preferably from 0.1 to 30 μm, and particularly preferably from 0.1 to 15 μm in order to ensure good properties and high processability of the molded article. The average particle size can be measured using a laser diffraction/scattering particle size analyzer such as “Microtrac MT310011” manufactured by Nikkiso Co., Ltd.

Among inorganic fillers, those belonging to silicate salts are preferred since such fillers can provide an increase in heat resistance and an improvement in processability. Among silicate salts, at least one selected from the group consisting of talc, mica, kaolinite, montmorillonite, and smectite is preferred since these silicate salts provide significant enhancement of the strength of the molded article and have such a narrow particle size distribution as to cause less deterioration in surface smoothness and mold transferability. Two or more silicate salts may be used in combination and, in this case, the types and proportions of the silicate salts can be adjusted as appropriate.

Examples of the talc include general-purpose talc and surface-treated talc, and specific examples include “MICRO ACE™” manufactured by Nippon Talc Co., Ltd., “Talcum Powder™” manufactured by Hayashi Kasei Co., Ltd., and talc manufactured by Takehara Kagaku Kogyo Co., Ltd. or Maruo Calcium Co., Ltd.

Examples of the mica include wet-ground mica and dry-ground mica, and specific examples include mica manufactured by Yamaguchi Mica Co., Ltd. or Keiwa Rozai Co., Ltd.

Examples of the kaolinite include dry kaolin, calcined kaolin, and wet kaolin, and specific examples include “TRANSLINK™”, “ASP™”, “SANTINTONE™”, and “ULTREX™” manufactured by Hayashi Kasei Co., Ltd. and kaolinite manufactured by Keiwa Rozai Co., Ltd.

When the resin composition for molding contains an inorganic filler as described above, the amount of the inorganic filler is preferably from 1 to 30 parts by weight per 100 parts by weight of the total resin component including the P3HA (A) and the reaction product (B) in terms of enhancing the strength of the molded article and ensuring the fluidity of the resin composition during melt molding. The amount of the inorganic filler is more preferably from 5 to 25 parts by weight.

### (Additives)

The resin composition for molding may contain additives other than inorganic fillers to the extent that the additives do not diminish the effect of the invention. Examples of the additives include a nucleating agent, a lubricant, a plasticizer, an antistatic agent, a flame retardant, a conductive additive, a heat insulator, a crosslinking agent, an antioxidant, an ultraviolet absorber, a colorant, an organic filler, and a hydrolysis inhibitor, and these additives can be used depending on the intended purpose. Biodegradable additives are particularly preferred.

Examples of the nucleating agent include pentaerythritol, orotic acid, aspartame, cyanuric acid, glycine, zinc phenylphosphonate, and boron nitride. Poly(3-hydroxybutyrate) can also be added as the nucleating agent. Among the mentioned compounds, pentaerythritol is preferred because it is particularly superior in the accelerating effect on crystallization of poly(3-hydroxyalkanoate) resins. One nucleating agent may be used alone, or two or more nucleating agents may be mixed. The mix proportions of the nucleating agents can be adjusted as appropriate depending on the intended purpose. The resin composition for molding need not contain any nucleating agent (in particular, pentaerythritol).

When a nucleating agent other than poly(3-hydroxybutyrate) is used, the amount of the nucleating agent is not limited to a particular range, but is preferably from 0.1 to 10 parts by weight, more preferably from 0.5 to 8.5 parts by weight, even more preferably from 0.7 to 6 parts by weight, and particularly preferably from 0.8 to 3 parts by weight per 100 parts by weight of the total amount of the P3HA (A) and the reaction product (B). When poly(3-hydroxybutyrate) is added as a nucleating agent, the amount of the poly(3-hydroxybutyrate) is not limited to a particular range, but is preferably from 0.1 to 15 parts by weight, more preferably from 1 to 10 parts by weight, even more preferably from 3 to 8 parts by weight, and particularly preferably from 4 to 7 parts by weight per 100 parts by weight of the total amount of the P3HA (A) and the reaction product (B), exclusive of the poly(3-hydroxybutyrate).

Examples of the lubricant include behenamide, oleamide, erucamide, stearamide, palmitamide, N-stearyl behenamide, N-stearyl erucamide, ethylenebisstearamide, ethylenebisoleamide, ethylenebiserucamide, ethylenebislauramide, ethylenebiscapramide, p-phenylenebisstearamide, and a polycondensation product of ethylenediamine, stearic acid, and sebacic acid. Among these, behenamide and erucamide are preferred because they are particularly superior in the lubricating effect on poly(3-hydroxyalkanoate) resins. One lubricant may be used alone, or two or more lubricants may be mixed. The mix proportions of the lubricants can be adjusted as appropriate depending on the intended purpose.

The amount of the lubricant used is not limited to a particular range, but is preferably from 0.01 to 5 parts by weight, more preferably from 0.05 to 3 parts by weight, and even more preferably from 0.1 to 1.5 parts by weight per 100 parts by weight of the total amount of the P3HA (A) and the reaction product (B).

Examples of the plasticizer include glycerin ester compounds, citric ester compounds, sebacic ester compounds, adipic ester compounds, polyether ester compounds, benzoic ester compounds, phthalic ester compounds, isosorbide ester compounds, polycaprolactone compounds, and dibasic ester compounds. Among these, glycerin ester compounds, citric ester compounds, sebacic ester compounds, and dibasic ester compounds are preferred because they are particularly superior in the plasticizing effect on poly(3-hydroxyalkanoate) resins. Examples of the glycerin ester compounds include glycerin diacetomonolaurate. Examples of the citric ester compounds include tributyl acetylcitrate. Examples of the sebacic ester compounds include dibutyl sebacate. Examples of the dibasic ester compounds include benzyl methyl diethylene glycol adipate. One plasticizer may be used alone, or two or more plasticizers may be mixed. The mix proportions of the plasticizers can be adjusted as appropriate depending on the intended purpose.

The amount of the plasticizer used is not limited to a particular range, but is preferably from 0 to 20 parts by weight, more preferably from 0 to 15 parts by weight, even more preferably from 0 to 10 parts by weight, and particularly preferably from 0 to 5 parts by weight per 100 parts by weight of the total resin component including the P3HA (A) and the reaction product (B).

### [Molded Article]

One embodiment of the present invention relates to a molded article made of the resin composition for molding. Being made of the resin composition for molding, the molded article contains a poly(3-hydroxyalkanoate) resin component and can have a small wall thickness. An example of such a molded article is a hollow molded article, examples of which include a resin tube and a bottle. Another example of the molded article is a film.

### [Resin Tube]

A “tube” as defined herein is a hollow, slender cylindrical molded article having a wall that has a generally constant thickness and that is generally circular in cross-section. Such a tube can be used as a straw or pipe. A resin tube according to the present embodiment can have a small wall thickness and is thus suitable for use as a straw.

When the resin tube is used as a straw, the wall thickness of the resin tube is preferably from 0.01 to 0.6 mm, more preferably from 0.05 to 0.5 mm, and even more preferably from 0.1 to 0.4 mm so that the straw may avoid collapsing when a beverage is sucked through the straw, that the straw may be flexible enough to resist breakage, that the straw may cause little injury when its end contacts a fingertip, and that the straw may be quickly biodegraded in seawater. According to the present embodiment, a resin tube can be produced which has a wall thickness as small as 0.01 to less than 0.2 mm or as small as 0.01 to less than 0.1 mm.

When the resin tube is used as a straw, the outer diameter of the resin tube is not limited to a particular range. In terms of the ease of use of the straw for drinking a beverage, the outer diameter is preferably from 2 to 10 mm, more preferably from 4 to 8 mm, and even more preferably from 5 to 7 mm.

The resin tube is generally circular in cross-section. The cross-sectional shape is preferably close to a true circle in terms of the usability of the resin tube as a straw. Thus, the degree of flattening of the cross-sectional shape of the tube, calculated by the formula [100×(maximum outer diameter−minimum outer diameter)/maximum outer diameter], is preferably 10% or less, more preferably 8% or less, even more preferably 5% or less, and still even more preferably 3% or less. When the degree of flattening is 0%, this means that the cross-sectional shape is a true circle.

The length of the resin tube is not limited to a particular range. When the resin tube is used as a straw, the length of the resin tube is preferably from 50 to 350 mm, more preferably from 70 to 300 mm, and even more preferably from 90 to 270 mm in terms of the ease of use of the straw for drinking a beverage.

The resin tube used as a straw may be a tube that has not been subjected to any secondary process or a tube that has been subjected to a secondary process such as formation of a stopper portion or corrugated portion. The secondary process may be performed under heating of the resin tube, but is preferably performed at normal temperature.

### [Bottle]

A “bottle” as defined herein is a hollow container having an upper inlet. Such a bottle can be used as a container for holding a beverage, a liquid food, a liquid detergent, or the like. A bottle according to the present embodiment can have a small wall thickness and can thus be reduced in weight.

### [Film]

A film according to the present embodiment can also have a small thickness and be reduced in weight. The film can be produced by any of various molding methods such as T-die extrusion molding, blown film molding, and calender molding. The film may be an unstretched film or may be a stretched film such as a uniaxially-stretched or biaxially-stretched film.

The thickness of the film is not limited to a particular range and may be from about 10 μm to about 1 mm. The thickness of the film is preferably from 5 to 500 μm and more preferably from 20 to 300 m.

The film is not limited to a particular use and may be used, for example, as a packaging film or a blister sheet.

A z-average molecular weight/weight-average molecular weight ratio (Mz/Mw) measured by GPC analysis for the resin composition for molding or molded article according to the present embodiment is preferably from 10 to 300. When the ratio is in this range, the molded article with a small wall thickness can be produced more easily. The ratio is preferably from 20 to 290, more preferably from 30 to 270, and even more preferably from 40 to 250.

Both the weight-average molecular weight (Mw) and the z-average molecular weight (Mz) are determined by GPC analysis. The Mw is a weighted average calculated by using the molecular weight as a weight, and the Mz is a weighted average calculated by using the square of the molecular weight as a weight. Thus, the Mz is more affected by the presence of a high-molecular-weight component than the Mw, and the higher the high-molecular-weight component content is, the greater the Mz is. Since the resin composition for molding or molded article according to the present embodiment contains the reaction product (B) of the resin (b1) and the organic peroxide (b2), it is inferred that the resin composition or molded article has a relatively high content of high-molecular-weight component and can exhibit a relatively high value of the z-average molecular weight/weight-average molecular weight ratio.

The weight-average molecular weight of the P3HA (A) or P3HA (b1) and the weight-average molecular weight and z-average molecular weight of the resin composition for molding or molded article can be measured as polystyrene-equivalent molecular weights by gel permeation chromatography (HPLC GPC system manufactured by Shimadzu Corporation) using a chloroform solution. The columns used in the gel permeation chromatography may be any columns suitable for molecular weight measurement.

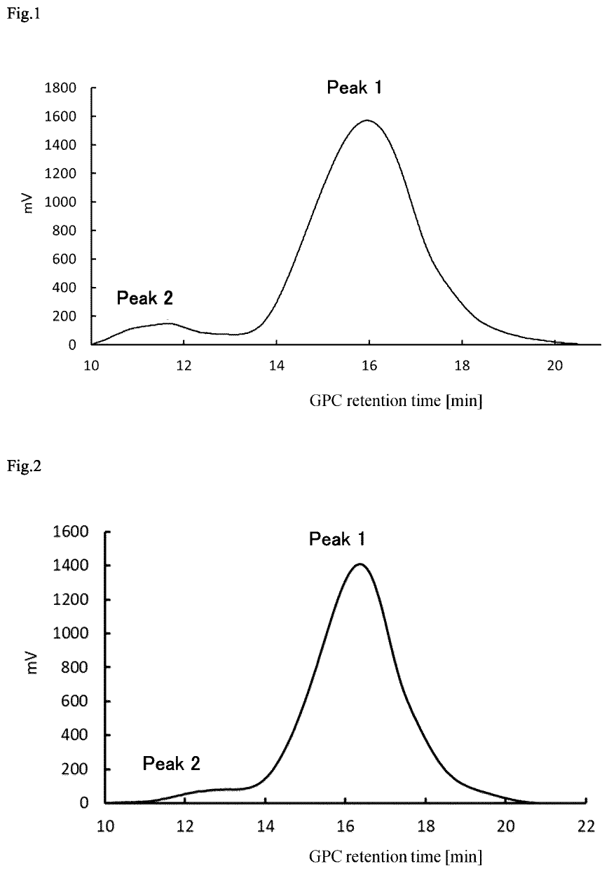

Preferably, the resin composition for molding or molded article according to the present embodiment exhibits two peak tops in a GPC chart obtained by GPC analysis for the resin composition for molding or molded article. These peak tops are thought of as a peak top indicating the presence of the P3HA (A) and a peak top indicating the presence of the reaction product (B), respectively. An example of such a GPC chart is shown in FIG. 1.

### [Method for Producing Molded Article]

Hereinafter, an example of the method for producing the molded article will be described in detail.

First, the reaction product (B) is obtained by reacting the P3HA (b1) and the organic peroxide (b2) in the way as previously described. Next, the P3HA (A) and the reaction product (B) are melted and kneaded, together with an additional resin, an inorganic filler, and other additives added as necessary, by using a device such as an extruder, a kneader, a Banbury mixer, or a roll mill, and thus a resin composition is prepared. The resin composition is extruded as a strand, which is then cut to obtain pellets in the form of cylindrical, elliptic cylindrical, spherical, cubic, or rectangular parallelepiped-shaped particles. Desirably, the pellets thus made are thoroughly dried at 40 to 80° C. to remove water before they are subjected to molding (in particular, extrusion molding).

The temperature for the melting and kneading depends on the properties such as melting point and melt viscosity of the resins used and cannot be definitely specified. The resin temperature of the melted kneaded product at the die outlet is preferably from 140 to 190° C., more preferably from 145 to 185° C., and even more preferably from 150 to 180° C. When the resin temperature of the melted kneaded product is 140° C. or higher, the resin component including the poly(3-hydroxyalkanoate) resins can be sufficiently melted. When the resin temperature is 190° C. or lower, thermal decomposition of the resin component including the poly(3-hydroxyalkanoate) resins can be prevented.

Next, the pellets made as above are melted in an extruder, and then the molten resin material is extruded from an annular die coupled to the outlet of the extruder. The extrudate is placed into water and thus solidified and molded into a tube. Alternatively, a blend of the components may be melted in an extruder, and then the molten blend may be directly molded into a tube without pelletization.

Alternatively, after the pellets made as above are melted in an extruder, the molten resin material may be extruded into a mold from an annular die coupled to the outlet of the extruder, then the mold may be closed to form a bottom part, and air may be blown into the plasticized resin material to mold the resin material into a bottle. Alternatively, a blend of the components may be melted in an extruder, and then the molten blend may be directly molded into a bottle without pelletization.

Alternatively, after the pellets made as above are melted in an extruder, the molten resin material may be extruded from a T-die coupled to the outlet of the extruder to mold the resin material into a film. Alternatively, a blend of the components may be melted in an extruder, and then the molten blend may be directly molded into a film without pelletization.

In the following items, preferred aspects of the present disclosure are listed. The present invention is not limited to the following items.

### [Item 1]

A resin composition for molding, containing:
a poly(3-hydroxyalkanoate) resin (A) including at least one copolymer of 3-hydroxybutyrate units and other hydroxyalkanoate units; and
a reaction product (B) of a poly(3-hydroxyalkanoate) resin (b1) and an organic peroxide (b2), the poly(3-hydroxyalkanoate) resin (b1) including at least one copolymer of 3-hydroxybutyrate units and other hydroxyalkanoate units, wherein
the poly(3-hydroxyalkanoate) resin (b1) includes a copolymer (b1-1) in which a content of the other hydroxyalkanoate units is from 1 to 6 mol % and/or a copolymer (b1-2) in which a content of the other hydroxyalkanoate units is from 24 to 99 mol %, and
a proportion of the poly(3-hydroxyalkanoate) resin (A) is from 20 to 99 wt % and a proportion of the reaction product (B) is from 1 to 80 wt % in a total amount of the poly(3-hydroxyalkanoate) resin (A) and the reaction product (B).

### [Item 2]

The resin composition for molding according to item 1, wherein the proportion of the poly(3-hydroxyalkanoate) resin (A) is from 20 to 80 wt % and the proportion of the reaction product (B) is from 20 to 80 wt % in the total amount of the poly(3-hydroxyalkanoate) resin (A) and the reaction product (B).

### [Item 3]

The resin composition for molding according to item 1 or 2, wherein the poly(3-hydroxyalkanoate) resin (b1) includes the copolymer (b1-1) and the copolymer (b1-2).

### [Item 4]

The resin composition for molding according to any one of items 1 to 3, wherein an amount of the organic peroxide (b2) is from 0.01 to 0.5 parts by weight per 100 parts by weight of the poly(3-hydroxyalkanoate) resin (b1).

### [Item 5]

The resin composition for molding according to any one of items 1 to 4, wherein a z-average molecular weight/weight-average molecular weight ratio (Mz/Mw) measured for the resin composition for molding is from 10 to 300.

### [Item 6]

The resin composition for molding according to any one of items 1 to 5, wherein a GPC chart of the resin composition for molding has two or more peak tops.

### [Item 7]

The resin composition for molding according to any one of items 1 to 6, wherein
an average content of the other hydroxyalkanoate units in the poly(3-hydroxyalkanoate) resin (A) is from 1 to 6 mol %, and
an average content of the other hydroxyalkanoate units in the poly(3-hydroxyalkanoate) resin (b1) is from 6 to 50 mol %.

### [Item 8]

The resin composition for molding according to any one of items 1 to 7, wherein each of the poly(3-hydroxyalkanoate) resin (A) and the poly(3-hydroxyalkanoate) resin (b1) includes at least one selected from the group consisting of poly(3-hydroxybutyrate-co-3-hydroxyvalerate), poly(3-hydroxybutyrate-co-3-hydroxyvalerate-co-3-hydroxyhexanoate), poly(3-hydroxybutyrate-co-3-hydroxyhexanoate), and poly(3-hydroxybutyrate-co-4-hydroxybutyrate).

### [Item 9]

The resin composition for molding according to item 8, wherein each of the poly(3-hydroxyalkanoate) resin (A) and the poly(3-hydroxyalkanoate) resin (b1) is poly(3-hydroxybutyrate-co-3-hydroxyhexanoate).

### [Item 10]

The resin composition for molding according to any one of items 1 to 9, wherein an amount of a resin other than the poly(3-hydroxyalkanoate) resin (A) and the reaction product (B) is from 0 to 35 parts by weight per 100 parts by weight of the total amount of the poly(3-hydroxyalkanoate) resin (A) and the reaction product (B).

### [Item 11]

The resin composition for molding according to any one of items 1 to 10, further containing a nucleating agent and/or a lubricant.

### [Item 12]

The resin composition for molding according to any one of items 1 to 11, further containing 1 to 30 parts by weight of an inorganic filler per 100 parts by weight of a total resin component including the poly(3-hydroxyalkanoate) resin (A) and the reaction product (B).

### [Item 13]

A molded article containing the resin composition for molding according to any one of items 1 to 12 and 18 to 20.

### [Item 14]

The molded article according to item 13, wherein the molded article is a resin tube, a bottle, or a film.

### [Item 15]

The molded article according to item 14, wherein the resin tube has a wall thickness of 0.01 to 0.6 mm.

### [Item 16]

A method for producing the molded article according to any one of items 13 to 15, the method including the steps of:
reacting the poly(3-hydroxyalkanoate) resin (b1) and the organic peroxide (b2) to obtain the reaction product (B);
mixing the reaction product (B) and the poly(3-hydroxyalkanoate) resin (A) to obtain a mixture; and
molding the mixture into a molded article.

### [Item 17]

The method according to item 16, wherein the step of molding the mixture into the molded article includes extrusion molding.

### [Item 18]

The resin composition for molding according to any one of items 1 to 12, wherein
the poly(3-hydroxyalkanoate) resin (b1) includes only the copolymer (b1-1), and
the content of the other hydroxyalkanoate units in the copolymer (b1-1) is from 1 to less than 6 mol %.

### [Item 19]

The resin composition for molding according to any one of items 1 to 12, wherein the poly(3-hydroxyalkanoate) resin (b1) includes only the copolymer (b1-2).

### [Item 20]

The resin composition for molding according to any one of items 1 to 12, 18, and 19, wherein an amount of a resin other than the poly(3-hydroxyalkanoate) resin (b1) in the reaction product (B) is from 0 to less than 5 parts by weight per 100 parts by weight of the resin composition for molding.

### EXAMPLES

Hereinafter, the present invention will be specifically described using examples. The technical scope of the present invention is not limited by the examples given below.

Listed below are materials used in Examples and Comparative Examples.
PHBH 3: P3HB3HH (average content ratio 3HB/3HH=97.1/2.9 (mol %/mol %), weight-average molecular weight=31×10⁴ g/mol)

This resin was produced according to a method described in Comparative Example 2 of WO 2019/142845.
PHBH 6: X331N (Kaneka Biodegradable Polymer PHBH™, average content ratio 3HB/3HH=94/6 (mol %/mol %), weight-average molecular weight=35×10⁴ g/mol)
PHBH 11: 151C (Kaneka Biodegradable Polymer PHBH™, average content ratio 3HB/3HH=89/11 (mol %/mol %), weight-average molecular weight=60×10⁴ g/mol)
PHBH 28: P3HB3HH (average content ratio 3HB/3HH=71.8/28.2 (mol %/mol %), weight-average molecular weight=66×10⁴ g/mol)

This resin was produced according to a method described in Example 9 of WO 2019/142845.
P3HB4HB: P3HB4HB (I6002 manufactured by Metabolix, average content ratio 3HB/4HB=55/45 (mol %/mol %))
PBSA: BioPBS™ FD92PM (polybutylene succinate adipate), manufactured by PTT MCC Biochem

### (Organic Peroxide)

Perbutyl I manufactured by NOF Corporation (t-butylperoxyisopropyl carbonate, one-minute half-life temperature=159° C.)

### (Additive-1: Nucleating Agent)

Pentaerythritol (Neulizer P manufactured by Mitsubishi Chemical Corporation)

### (Additives-2 and 3: Lubricants)

Erucamide and behenamide

The following describes evaluation methods used in Examples and Comparative Examples.

### <Measurement of Weight-Average Molecular Weight and Z-Average Molecular Weight>

The weight-average molecular weight and the z-average molecular weight of each of the resin tubes obtained in Examples and Comparative Examples were measured as follows. First, the resin tube was dissolved in chloroform, and the solution was heated in a hot water bath at 60° C. for 0.5 hours. The heated solution was passed through a disposable filter made of PTFE and having a pore diameter of 0.45 μm, and the filtrate was subjected to GPC analysis under conditions listed below to measure the weight-average molecular weight and the z-average molecular weight, from which the z-average molecular weight/weight-average molecular weight ratio was determined.
GPC system: High-performance liquid chromatograph 20A system manufactured by Shimadzu Corporation
Columns: K-G 4A (one column) and K-806M (two columns) manufactured by Showa Denko K.K.
Sample concentration: 1 mg/ml
Eluent: Chloroform solution
Eluent flow rate: 1.0 ml/min
Amount of injected sample: 100 μL
Analysis time: 30 minutes
Standard sample: Standard polystyrene

A chart obtained by the GPC analysis for the resin tube of Example 1 is shown in FIG. 2.

### Example 1

First, to produce the component (B), 1.75 kg of PHBH 6, 1.75 kg of PHBH 28, and 4.2 g of organic peroxide were dry-blended to give resin proportions shown in Table 1. The resulting resin material was placed into and extruded by a 26-mm-diameter corotating twin-screw extruder whose cylinder temperature was set to 150° C. and whose die temperature was set to 150° C. The extruded resin material in the shape of a strand was passed through a water bath filled with 40° C. hot water to solidify the strand, which was cut by a pelletizer to obtain pellets of the component (B).

Subsequently, 1.5 kg of PHBH 6 as the component (A) was dry-blended with 50 g of Additive-1, 25 g of Additive-2, and 25 g of Additive-3. The resulting resin material (component (A)+additives) and the above pellets of the component (B) were placed into and extruded by a 26-mm-diameter corotating twin-screw extruder whose cylinder temperature was set to 150° C. and whose die temperature was set to 150° C. The extruded resin material in the shape of a strand was passed through a water bath filled with 40° C. hot water to solidify the strand, which was cut by a pelletizer to obtain resin composition pellets.

The cylinder temperature and die temperature of a 50-mm-diameter single-screw extruder, to which an annular die (outer diameter=15 mm, inner diameter=13.5 mm) was coupled, were set to 165° C. The resin composition pellets were placed into the extruder and extruded as a tube at a screw rotational speed of 7.3 rpm. The extruded tube was passed through a 40° C. water bath located 100 mm away from the annular die and was then hauled off at a speed of 10 m/min. As a result, a resin tube with an outer diameter of 5 mm and a wall thickness of 0.08 mm was successfully obtained, and high moldability in tube production was demonstrated. The resin tube was evaluated for the weight-average molecular weight and the z-average molecular weight.

### Examples 2 to 10 and Comparative Examples 1 to 4

Resin composition pellets were produced in the same manner as in Example 1, except that the components and their proportions were changed as shown in Table 1, and evaluation procedures identical to those in Example 1 were conducted. The results are summarized in Table 1.

TABLE 1

| | Component (A) | | | | | | | | |
|---|---|---|---|---|---|---|---|---|---|
| | | | | | Average content | | | | |
| | | | | | of other HA | Component (B) | | | |
| | First component | | Second component | | units in | First component (b1) | | Second component (b1) | |
| | | Content | | Content | component (A) | | Content | | Content |
| | Type | (wt %) | Type | (wt %) | (mol %) | Type | (wt %) | Type | (wt %) |
| Ex. 1 | PHBH 6 | 30 | — | — | 6 | PHBH 6 | 35 | PHBH 28 | 35 |
| Ex. 2 | PHBH 6 | 70 | — | — | 6 | PHBH 6 | 15 | PHBH 28 | 15 |
| Ex. 3 | PHBH 6 | 70 | — | — | 6 | PHBH 6 | 15 | PHBH 28 | 15 |
| Ex. 4 | PHBH 3 | 70 | — | — | 3 | PHBH 3 | 15 | PHBH 28 | 15 |
| Ex. 5 | PHBH 3 | 70 | — | — | 3 | PHBH 3 | 15 | PHBH 28 | 15 |
| Ex. 6 | PHBH 3 | 70 | — | — | 3 | PHBH 3 | 15 | PHBH 28 | 15 |
| Ex. 7 | PHBH 3 | 30 | — | — | 3 | PHBH 3 | 50 | P3HB4HB | 20 |
| Ex. 8 | PHBH 3 | 80 | — | — | 3 | PHBH 28 | 20 | — | — |
| Ex. 9 | PHBH 3 | 80 | — | — | 3 | P3HB4HB | 20 | — | — |
| Ex. 10 | PHBH 6 | 25 | — | — | 6 | PHBH 3 | 75 | — | — |
| Comp. 1 | PHBH 6 | 70 | PHBH 11 | 30 | 7.5 | — | — | — | — |
| Comp. 2 | PHBH 6 | 30 | PHBH 11 | 70 | 9.5 | — | — | — | — |
| Comp. 3 | — | — | | | — | PHBH 3 | 100 | — | — |
| Comp. 4 | PHBH 6 | 25 | — | — | 6 | PHBH 11 | 75 | — | — |

| | Component (B) | | | | | |
|---|---|---|---|---|---|---|
| | Average content | Amount of | Other components | | | |
| | of other HA | organic peroxide | | Amount per 100 | | Moldability in |
| | units in | (b2) per 100 | | parts of total amount | | production of tube |
| | component (b1) | parts of (b1) | | of (A) and (B) | | with wall thickness |
| | (mol %) | (parts by weight) | Material | (parts by weight) | Mz/Mw | of 80 μm |
| Ex. 1 | 17 | 0.12 | — | — | 144 | Good |
| Ex. 2 | 17 | 0.12 | — | — | 62 | Good |
| Ex. 3 | 17 | 0.41 | — | — | 223 | Good |
| Ex. 4 | 16 | 0.12 | — | — | 84 | Good |
| Ex. 5 | 16 | 0.12 | PBSA | 25 | 44 | Good |
| Ex. 6 | 16 | 0.12 | Talc | 25 | 55 | Good |
| Ex. 7 | 8 | 0.12 | — | — | 288 | Good |
| Ex. 8 | 28 | 0.12 | — | — | 39 | Good |
| Ex. 9 | 45 | 0.15 | — | — | 148 | Good |
| Ex. 10 | 3 | 0.12 | — | — | 182 | Good |
| Comp. 1 | — | — | — | — | 1.6 | Poor |
| Comp. 2 | — | — | — | — | 1.8 | Poor |
| Comp. 3 | 3 | 0.12 | — | — | 1.8 | Poor |
| Comp. 4 | 11 | 0.12 | — | — | 167 | Poor |

In Examples 1 to 10, molding into resin tubes with a wall thickness as small as 80 m was successfully accomplished. In Comparative Example 1 or 2, where the pellets contained the P3HA (A) but did not contain the reaction product (B), molding into a resin tube failed because gas pressure used in the tube production made a hole in a resin film being molded. In Comparative Example 3, where the pellets contained only the reaction product (B) and did not contain the P3HA (A), low moldability and insufficient crystallization resulted in failure of molding into a resin tube.

In Comparative Example 4, the pellets contained the P3HA (A) and the reaction product (B), but the resin used in the reaction product (B) was neither the copolymer (b1-1) nor the copolymer (b1-2). This resulted in insufficient crystallization leading to failure of molding into a resin tube.

What is claimed is:

1. A resin composition for molding, comprising:
a poly(3-hydroxyalkanoate) resin (A) comprising at least one copolymer of 3-hydroxybutyrate units and other hydroxyalkanoate units; and
a reaction product (B) of a poly(3-hydroxyalkanoate) resin (b1) and an organic peroxide (b2), the poly(3-hydroxyalkanoate) resin (b1) comprising at least one copolymer of 3-hydroxybutyrate units and other hydroxyalkanoate units, wherein
the poly(3-hydroxyalkanoate) resin (b1) comprises a copolymer (b1-1) in which a content of the other hydroxyalkanoate units is from 1 to 6 mol % and/or a copolymer (b1-2) in which a content of the other hydroxyalkanoate units is from 24 to 99 mol %, and
a proportion of the poly(3-hydroxyalkanoate) resin (A) is from 20 to 99 wt % and a proportion of the reaction product (B) is from 1 to 80 wt % in a total amount of the poly(3-hydroxyalkanoate) resin (A) and the reaction product (B).

2. The resin composition for molding according to claim 1, wherein the proportion of the poly(3-hydroxyalkanoate) resin (A) is from 20 to 80 wt % and the proportion of the reaction product (B) is from 20 to 80 wt % in the total amount of the poly(3-hydroxyalkanoate) resin (A) and the reaction product (B).

3. The resin composition for molding according to claim 1, wherein the poly(3-hydroxyalkanoate) resin (b1) comprises the copolymer (b1-1) and the copolymer (b1-2).

4. The resin composition for molding according to claim 1, wherein an amount of the organic peroxide (b2) is from 0.01 to 0.5 parts by weight per 100 parts by weight of the poly(3-hydroxyalkanoate) resin (b1).

5. The resin composition for molding according to claim 1, wherein a z-average molecular weight/weight-average molecular weight ratio (Mz/Mw) measured for the resin composition for molding is from 10 to 300.

6. The resin composition for molding according to claim 1, wherein a GPC chart of the resin composition for molding has two or more peak tops.

7. The resin composition for molding according to claim 1, wherein
an average content of the other hydroxyalkanoate units in the poly(3-hydroxyalkanoate) resin (A) is from 1 to 6 mol %, and
an average content of the other hydroxyalkanoate units in the poly(3-hydroxyalkanoate) resin (b1) is from 6 to 50 mol %.

8. The resin composition for molding according to claim 1, wherein each of the poly(3-hydroxyalkanoate) resin (A) and the poly(3-hydroxyalkanoate) resin (b1) comprises at least one selected from the group consisting of poly(3-hydroxybutyrate-co-3-hydroxyvalerate), poly(3-hydroxybutyrate-co-3-hydroxyvalerate-co-3-hydroxyhexanoate), poly(3-hydroxybutyrate-co-3-hydroxyhexanoate), and poly(3-hydroxybutyrate-co-4-hydroxybutyrate).

9. The resin composition for molding according to claim 8, wherein each of the poly(3-hydroxyalkanoate) resin (A) and the poly(3-hydroxyalkanoate) resin (b1) is poly(3-hydroxybutyrate-co-3-hydroxyhexanoate).

10. The resin composition for molding according to claim 1, wherein an amount of a resin other than the poly(3-hydroxyalkanoate) resin (A) and the reaction product (B) is from 0 to 35 parts by weight per 100 parts by weight of the total amount of the poly(3-hydroxyalkanoate) resin (A) and the reaction product (B).

11. The resin composition for molding according to claim 1, further comprising a nucleating agent and/or a lubricant.

12. The resin composition for molding according to claim 1, further comprising 1 to 30 parts by weight of an inorganic filler per 100 parts by weight of a total resin component comprising the poly(3-hydroxyalkanoate) resin (A) and the reaction product (B).

13. A molded article comprising the resin composition for molding according to claim 1.

14. The molded article according to claim 13, wherein the molded article is a resin tube, a bottle, or a film.

15. The molded article according to claim 14, wherein the resin tube has a wall thickness of 0.01 to 0.6 mm.

16. A method for producing the molded article according to claim 13, the method comprising the steps of:
reacting the poly(3-hydroxyalkanoate) resin (b1) and the organic peroxide (b2) to obtain the reaction product (B);
mixing the reaction product (B) and the poly(3-hydroxyalkanoate) resin (A) to obtain a mixture; and
molding the mixture into a molded article.

17. The method according to claim 16, wherein the step of molding the mixture into the molded article comprises extrusion molding.

18. The resin composition for molding according to claim 1, wherein
the poly(3-hydroxyalkanoate) resin (b1) comprises only the copolymer (b1-1), and
the content of the other hydroxyalkanoate units in the copolymer (b1-1) is from 1 to less than 6 mol %.

19. The resin composition for molding according to claim 1, wherein the poly(3-hydroxyalkanoate) resin (b1) comprises only the copolymer (b1-2).

20. The resin composition for molding according to claim 1, wherein an amount of a resin other than the poly(3-hydroxyalkanoate) resin (b1) in the reaction product (B) is from 0 to less than 5 parts by weight per 100 parts by weight of the resin composition for molding.
